(19) United States
(12) Patent Application Publication
(10) Pub. No.: US 2002/0142276 A1
(43) Pub. Date: Oct. 3, 2002

(54) Solar system in a box

(76) Inventor: Matthew D. Marhefka, Doylestown, PA (US)

Correspondence Address: NORMAN E. LEHRER, 1205 North Kings Highway,, Cherry Hill, NJ, 08034, US

(21) Appl. No.: 09/820,607

(22) Filed: Mar. 30, 2001

(51) Int. Cl. G09B 23/00; G09B 27/00

(52) U.S. Cl. 434/284

(57) ABSTRACT

An educational toy which allows a user to experience the true scale of our solar system is disclosed. The toy includes a box with a tape or strip of paper contained within the box. The length of the tape when it is unwound represents a scaled distance between the earth and the sun. Located at a first end of the tape is a dot representing the earth. Located at a second end, opposite the first end of the tape is a circle representing the sun. The sizes of the dot and of the circle represent the relative size of the earth and sun when they are spaced at the scaled distance.

### BACKGROUND OF THE INVENTION

The present invention is directed toward an educational toy and more particularly, toward an educational toy which allows the user of the toy to experience the true scale of our solar system within the boundaries of an average home or schoolroom.

A difficult concept for people to comprehend is the enormity of our solar system. For example, the actual distance between the earth and the sun is 93,000,000 miles. An ordinary person generally finds this to be a difficult distance to image. Furthermore, if a scale model of the entire solar system were constructed within the boundaries of an average home or schoolroom, the planets and the sun would not be visible because they would be too small.

There are many two and three dimensional models of our solar system that are available and can be used as educational tools. These models are often used to illustrate the geometry and positional relationship between the planets of our solar system as well as the positional relationship between the planets and the sun. One of the disadvantages of these models, however, is that one cannot fully appreciate the actual dimensions of the sun and planets or the distances between the sun and the planets.

Therefore, a need exists for an educational tool which aids a person to comprehend the enormity of our solar system.

### SUMMARY OF THE INVENTION

The present invention is designed to overcome the deficiencies of the prior art discussed above. It is an object of the present invention to provide an educational toy which allows the user of the toy to gain an understanding of the true scale of our solar system.

It is another object of the present invention to provide an educational toy which may be used within an average home or schoolroom.

In accordance with the illustrative embodiments demonstrating features and advantages of the present invention, there is provided an educational toy which includes a box with a tape or strip of paper contained therein. The length of the tape when it is unwound represents a scaled distance between the earth and the sun. Located at one end of the tape is a dot representing the earth. Located at the opposite end of the tape is a circle representing the sun. The sizes of the dots and of the circle represent the relative size of the earth and sun when they are spaced at this scaled distance.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 is a perspective view of the toy of the present invention including a box and with the box closed;

FIG. 2 is a perspective view of the toy of the present invention within the box and with the cover of the box opened;

FIG. 3 is a perspective view of the toy of the present invention taken out of the box;

FIG. 4 illustrates the toy of the present invention being unwound; and

FIG. 5 illustrates the toy of the present invention unwound with the circle representing the sun opened.

### DETAILED DESCRIPTION OF THE PREFERRED EMBODIMENT

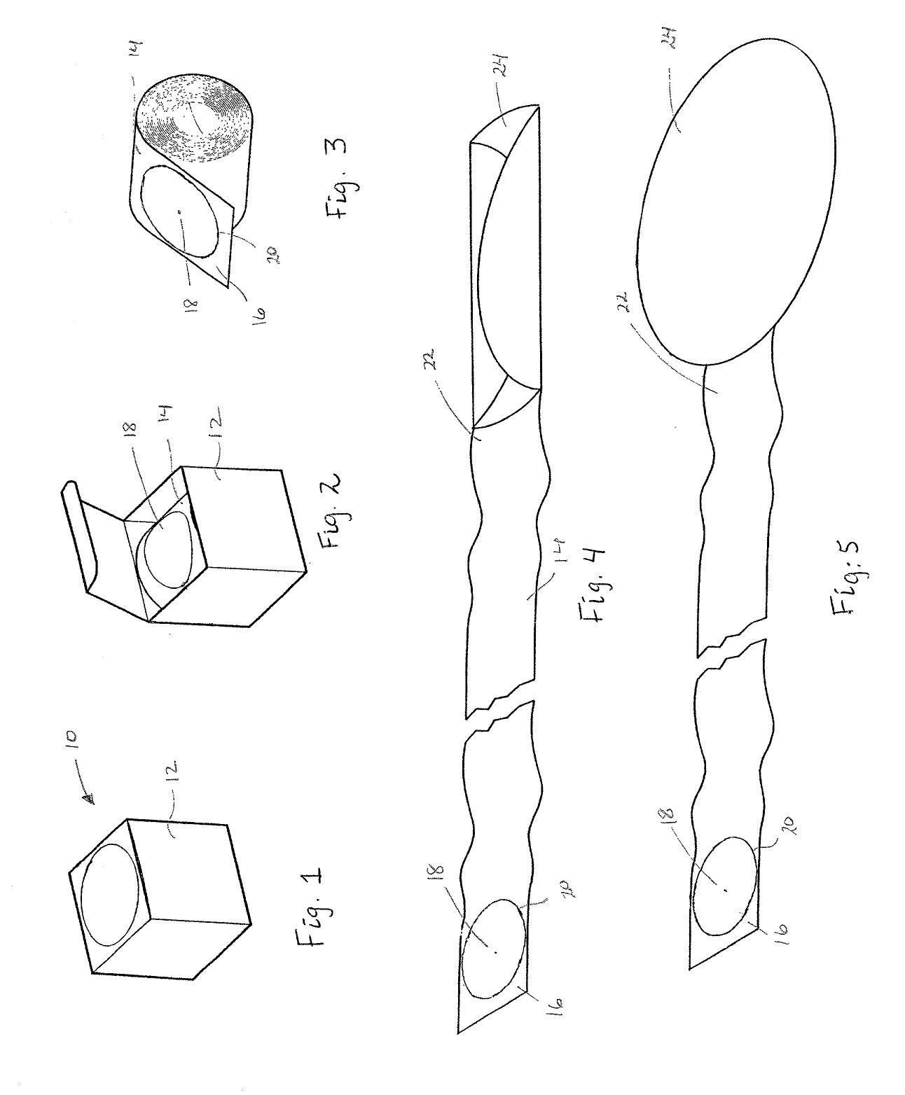

Referring now to the drawings in detail wherein like reference numerals have been used throughout the various figures to designate like elements, there is shown in FIG. 1 an educational toy constructed in accordance with the principles of the present invention and designated generally as 10.

The educational toy of the present invention essentially includes a box or housing 12 and a strip 14 of paper, tape, or the like material which is 38.307 feet long. The tape 14 is spirally wound and stored within the box 12. (See FIGS. 1 and 2.) Located adjacent a first end 16 of the tape 14 is a dot 18 having a diameter of 0.040 inches which represents a scaled size of the earth. The dot 18 may be drawn on the tape 14 or it may be a separate piece of material that is adhesively attached. In order to make the dot 18 more readily identifiable, the dot 18 is located within a circle 20. The circle 20 does not represent any part of the solar system. It merely makes it easier for a teacher or student to find the dot that represents the earth.

Located adjacent the other end 22 of the tape 14 is a second circle 24. Circle 24 is preferably made from an additional piece of paper or similar material that can be folded as shown in FIG. 4 and which is attached to the tape 14 at the second end 22. The diameter of the circle 24 is 4.325 inches which represents a scaled size of the sun.

In order to use the present invention, the box 12 is opened and the tape 14 is removed therefrom. The dot 18 which represents the earth is visible. The tape 14 is then unwound and stretched out to its full length. At the second end 22 of the tape 14, the circle 24 which represents the sun is in a folded position. (See FIG. 4.) The sun 24 is then unfolded so that the full size of the sun is visible. The user may now gain an understanding of the relative size of the earth and sun and the relative distance between them when spaced 38.307 feet apart.

The dimensions of the earth and sun represented in the present invention are based on a scaled distance between the earth and the sun. The dimensions are based on a scale of 0.000005 of the actual sizes. (The actual diameter of the earth is 8,000 miles and the actual diameter of the sun is 875,000 miles. The actual distance between the earth and the sun is 93,000,000 miles.) This scale was determined based on the observation that if the earth had a diameter smaller than 0.040 inches, it would be perceived as a speck without dimension. If the earth had a diameter greater than 0.040, the distance to the sun as recorded by the tape would be unmanageable within the boundaries of the average home or schoolroom. With the present invention a user gains a better understanding of the actual distance between the earth and the sun as well as the relative size of the earth and the sun.

One of the exercises a user of the present invention may perform is determining the location of the planets Mercury and Venus with relation to the sun. That is, the scaled distances can be determined by multiplying the actual distances by 0.000005. The distances may then be measured on the tape so that the location of each planet may be drawn on the tape. The same determination may be made for the earth's moon.

Another exercise that may be performed is when one person holds the earth end of the tape and another person holds up the sun end of the tape. To the person holding the earth end, the sun will appear to be exactly the same size as the real sun appears in the sky.

The present invention may be embodied in other specific forms without departing from the spirit or essential attributes thereof and accordingly, reference should be made to the appended claims rather than to the foregoing specification as indicating the scope of the invention.

I claim:

1. An educational toy for allowing a user to experience the true scale of our solar system comprising:
a strip of material have a first end and a second end;
a first representative means located at said first end of said strip;
a second representative means located at said second end of said strip, and
wherein said first representative means represents a scaled size of the earth, said second representative means represents a scaled size of the sun, and the length of said strip represents a scaled distance between the earth and the sun and wherein said scaled sizes and said scaled distance are the same.

2. The educational toy claimed in claim 1 wherein said first representative means is a dot having a diameter of 0.040 inches.

3. The educational toy claimed in claim 1 wherein the said second representative means is a circle having a diameter of 3.325 inches.

4. The educational toy claimed in claim 1 wherein the length of said strip is 38.307 feet.

5. The educational toy claimed in claim 1 wherein the dimensions of said first and second representative means and the distance between said first and second representative means is based on a scale of 0.000005 of the actual dimensions of the earth and sun and the distance between them.

6. The educational toy claimed in claim 1 further including a housing within which said strip of material is contained.
